(19) United States
(12) Patent Application Publication
(10) Pub. No.: US 2019/0039590 A1
(43) Pub. Date: Feb. 7, 2019

(54) Brake Apparatus, Brake System, and Master Cylinder

(71) Applicant: Hitachi Automotive Systems, Ltd., Hitachinaka-shi, Ibaraki (JP)

(72) Inventors: Ryohei MARUO, Kawasaki-shi, Kanagawa (JP); Chiharu NAKAZAWA, Kawasaki-shi, Kanagawa (JP); Hiroshi OWADA, Yokohama-shi, Kanagawa (JP); Naganori KOSHIMIZU, Kai-shi, Yamanashi (JP)

(21) Appl. No.: 16/076,525

(22) PCT Filed: Feb. 3, 2017
(86) PCT No.: PCT/JP2017/003917

§ 371 Date: Aug. 8, 2018

(30) Foreign Application Priority Data
Feb. 16, 2016 (JP) 2016-026640

(51) Int. Cl. B60T 17/22; B60T 11/16; B60T 13/58; B60T 8/40; G01D 5/14

(52) U.S. Cl. CPC B60T 17/221; B60T 11/165; B60T 13/66; B60T 8/4081; G01D 5/145; B60T 13/58

(57) ABSTRACT

Provided are a brake apparatus, a brake system, and a master cylinder that can accurately detect a movement amount of a piston while reducing manufacturing cost. A brake apparatus includes a master cylinder housing including a cylinder therein, a piston provided inside the cylinder and movable in a direction of an axial line of the cylinder, a magnet provided, inside the cylinder, partially in a circumferential direction of the piston, which is a direction around the axial line, and configured to be displaced according to a movement of the piston, a detection portion provided on the master cylinder housing and configured to detect a movement amount of the piston, and a rotation restriction mechanism provided inside the cylinder and configured to restrict a movement of the magnet in the circumferential direction.

### TECHNICAL FIELD

The present invention relates to a brake apparatus, a brake system, and a master cylinder.

### BACKGROUND ART

PTL 1 discloses a technique that provides an annular magnet attached to an outer periphery of a piston and detects a movement amount of the piston with use of a detection portion fixed to a master cylinder housing.

### CITATION LIST

### Patent Literature

PTL 1: Japanese Patent Application Public Disclosure No. 2015-098289

### SUMMARY OF INVENTION

### Technical Problem

One possible configuration regarding the above-described conventional technique is to provide the magnet partially in a circumferential direction of the piston from the viewpoint of reducing manufacturing cost. However, this configuration raises such a problem that a radial distance between the magnet and the detection portion increases if the piston is rotated, which results in a reduction in accuracy of the detection of the movement amount of the piston.

An object of the present invention is to provide a brake apparatus, a brake system, and a master cylinder that can accurately detect the movement amount of the piston while reducing the manufacturing cost.

### Solution to Problem

According to one embodiment of the present invention, a brake apparatus includes a rotation restriction mechanism provided inside a cylinder and configured to restrict a movement of a magnet in a circumferential direction.

Therefore, according to the one embodiment of the present invention, it is possible to accurately detect the movement amount of the piston while reducing the manufacturing cost.

### BRIEF DESCRIPTION OF DRAWINGS

FIG. 1 schematically illustrates a configuration of a brake system according to a first embodiment together with a hydraulic circuit.

FIG. 2 is a perspective view of the brake system according to the first embodiment.

FIG. 3 is a right side view of a first unit 1A according to the first embodiment.

FIG. 4 is a left side view of the first unit 1A according to the first embodiment.

FIG. 5 is a front view of the first unit 1A according to the first embodiment.

FIG. 6 is a cross-sectional view taken along a line S6-S6 illustrated in FIG. 3.

FIG. 7 is a cross-sectional view of the first embodiment taken along a line S7-S7 illustrated in FIG. 5.

FIG. 8 is a cross-sectional view of the first embodiment taken along a line S8-S8 illustrated in FIG. 4.

FIG. 9 is a partial cross-sectional perspective view of a master cylinder 5 according to the first embodiment.

FIG. 10 is an exploded perspective view of a stroke sensor 94 according to the first embodiment.

FIG. 11 illustrates a relationship between an input rod stroke and a sensor output of the stroke sensor 94.

FIG. 12 is a cross-sectional view of a second embodiment taken along the line S7-S7 illustrated in FIG. 5.

FIG. 13 is a cross-sectional view of the second embodiment taken along the line S8-S8 illustrated in FIG. 4.

FIG. 14 is a cross-sectional view of a third embodiment taken along the line S8-S8 illustrated in FIG. 4.

FIG. 15 is a perspective view of a magnet holder 97 according to a fourth embodiment.

### DESCRIPTION OF EMBODIMENTS

### First Embodiment

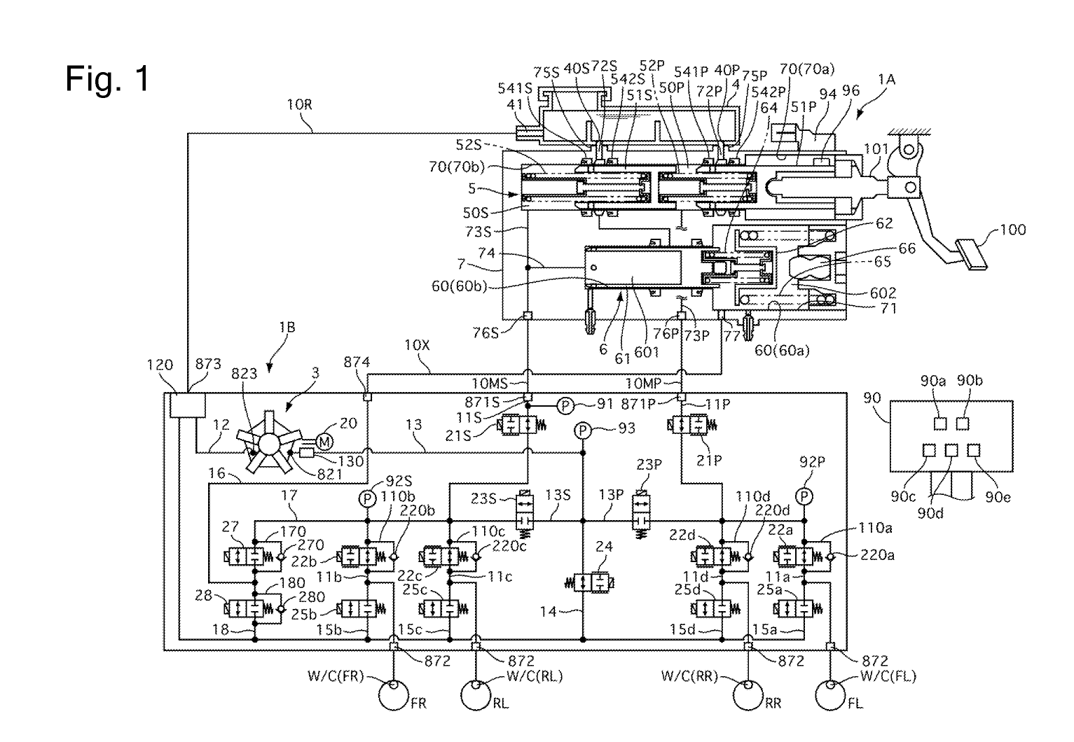

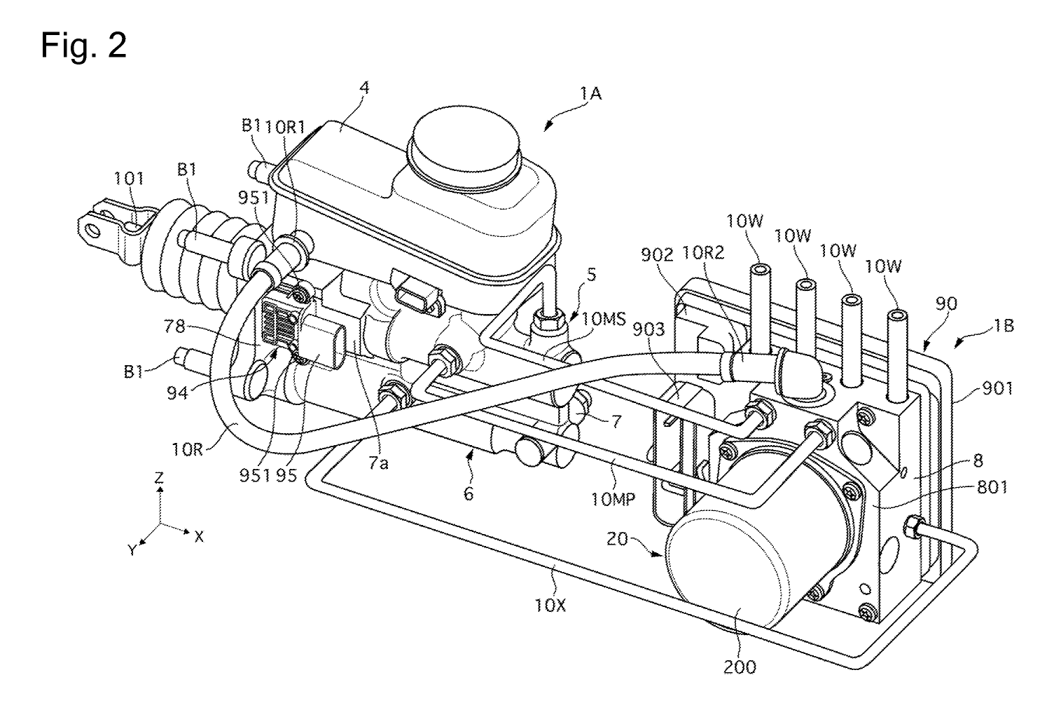

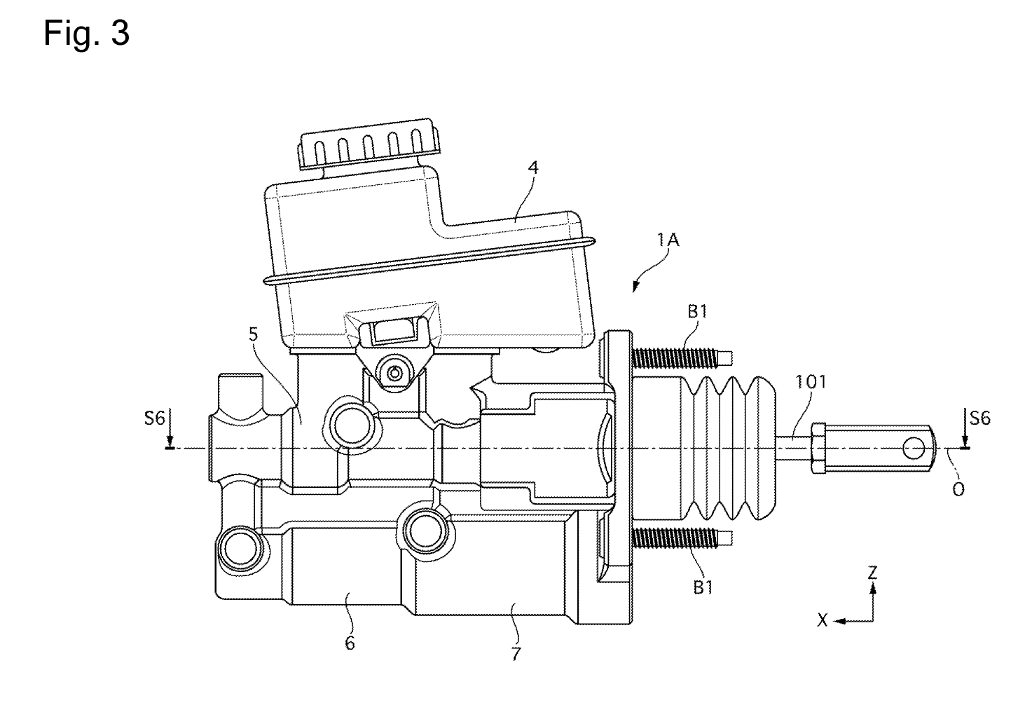

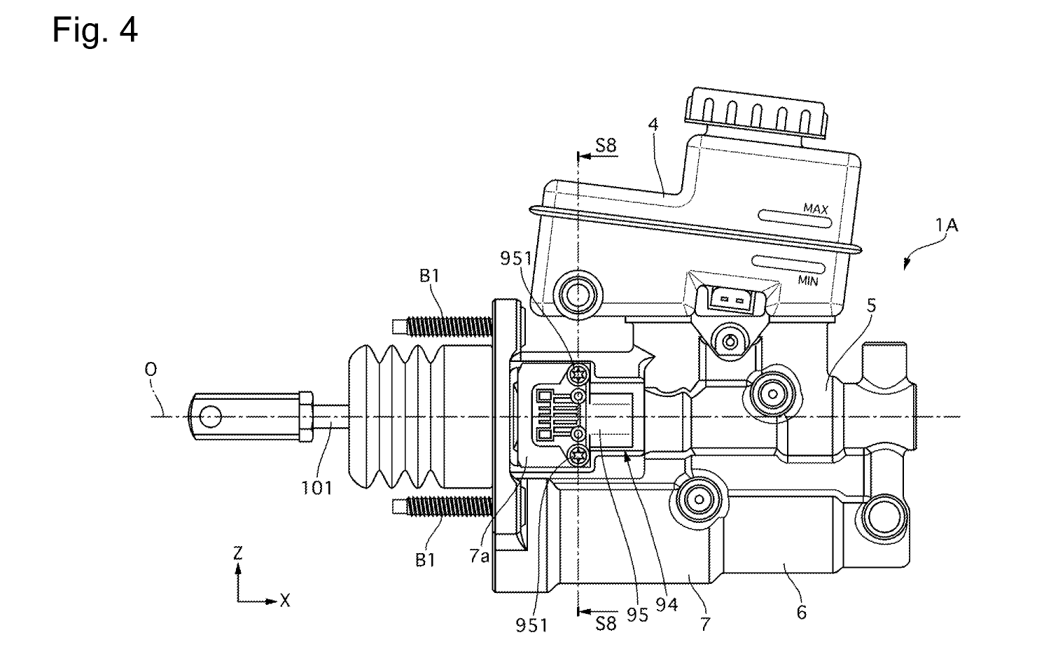

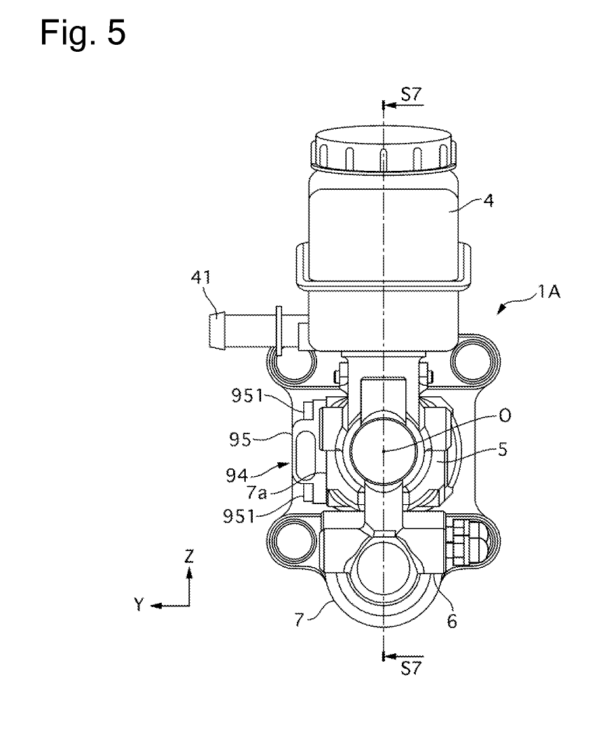

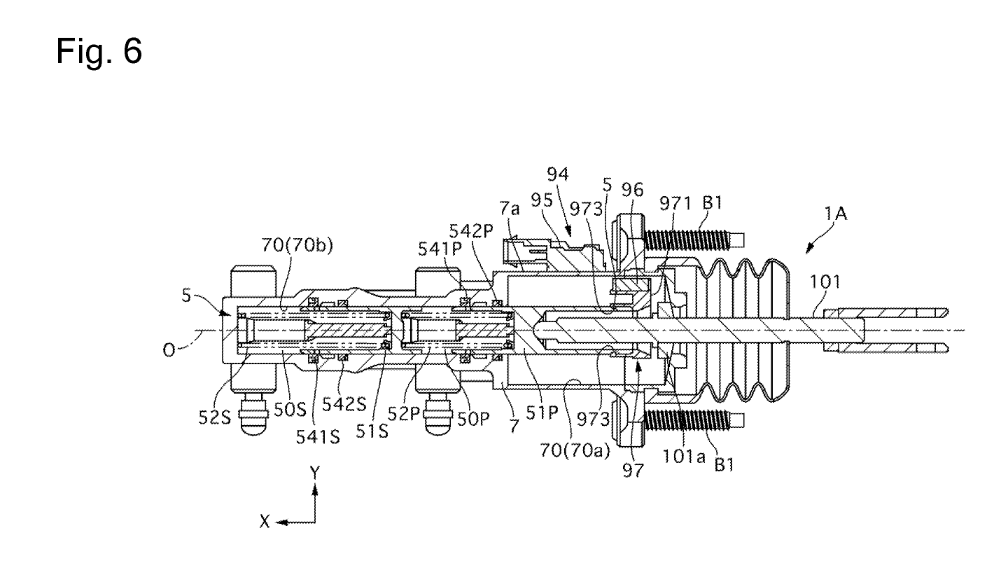

FIG. 1 schematically illustrates a configuration of a brake system according to a first embodiment together with a hydraulic circuit. FIG. 2 is a perspective view of the brake system according to the first embodiment. FIG. 3 is a right side view of a first unit 1A according to the first embodiment. FIG. 4 is a left side view of the first unit 1A according to the first embodiment. FIG. 5 is a front view of the first unit 1A according to the first embodiment. FIG. 6 is a cross-sectional view taken along a line S6-S6 illustrated in FIG. 3.

The brake system according to the first embodiment is employed for an electric vehicle. The electric vehicle is, for example, a hybrid automobile including an engine and a motor generator as a prime mover that drives wheels, or an electric automobile including only the motor generator as the prime mover. The electric automobile can carry out regenerative braking for braking the vehicle by regenerating electric energy from kinetic energy of the vehicle with use of a regenerative braking apparatus including the motor generator. The brake system applies a frictional braking force with use of a hydraulic pressure to each of wheels FL to RR of the vehicle. A brake actuation unit is provided to each of the wheels FL to RR. The brake actuation unit is a hydraulic pressure generation portion including a wheel cylinder W/C. The brake actuation unit is, for example, a disk-type brake, and includes a caliper (a hydraulic brake caliper). The caliper includes a brake disk and brake pads. The brake disk is a brake rotor rotatable integrally with a tire. The brake pads are disposed with predetermined clearances from the brake disk, and contact the brake disk by being moved by a hydraulic pressure in the wheel cylinder W/C. The frictional braking force is generated by the contacts of the brake pads to the brake disk. The brake system includes brake pipes of two systems (a primary P system and a secondary S system). A brake pipe configuration is, for example, an X-split pipe configuration. The brake system may employ another pipe configuration, such as a front/rear split pipe configuration. Hereinafter, when a member provided in correspondence with the P system and a member provided in correspondence with the S system should be distinguished from each other, indices P and S will be added at the ends of the respective reference numerals. The brake system supplies brake fluid as hydraulic fluid (hydraulic oil) to each of the brake actuation units via a brake pipe, and generates a brake hydraulic pressure (a working hydraulic pressure) in the wheel cylinder W/C. By this operation, the brake system applies a hydraulic braking force to each of the wheels FL to RR.

The brake system includes a first unit 1A and a second unit 1B. The first unit 1A and the second unit 1B are set up in, for example, a motor room isolated from a driving compartment of the vehicle. These units 1A and 1B are connected to each other via a plurality of pipes. The plurality of pipes includes master cylinder pipes 10M (a primary pipe 10MP and a secondary pipe 10MS), wheel cylinder pipes 10W, a backpressure chamber pipe 10X, and an intake pipe 10R. Except for the intake pipe 10R, each of the pipes 10M, 10W, and 10X is a metallic brake pipe (a metallic pipe), and, in particular, a steel tube such as a double walled steel tube. Each of the pipes 10M, 10W, and 10X includes a linear portion and a bent portion, and is disposed between ports by being turned in another direction at the bent portion. Both ends of each of the pipes 10M, 10W, and 10X each include a male pipe joint processed by flared processing. The intake pipe 10R is a brake hose (a hose pipe) formed so as to become flexible from a material such as rubber. Ends of the intake pipe 10R are connected to a port 873 and the like via nipples 10R1 and 10R2. The nipples 10R1 and 10R2 are each a synthetic resin connection member including a tubular portion.

A brake pedal 100 is a brake operation member that receives an input of a brake operation performed by a driver. An input rod 101 is vertically rotatably connected to the brake pedal 100. The first unit 1A is a master cylinder unit including a brake operation unit mechanically connected to the brake pedal 100, and a master cylinder 5. The first unit 1A includes a reservoir tank 4, a master cylinder housing 7, the master cylinder 5, a stroke sensor 94, and a stroke simulator 6. The reservoir tank 4 is a brake fluid source storing the brake fluid therein, and is a low-pressure portion opened to an atmospheric pressure. Replenishment ports 40 and a supply port 41 are provided in the reservoir tank 4. The intake pipe 10R is connected to the supply port 41. The master cylinder housing 7 is a casing that contains (houses) the master cylinder 5 and the stroke simulator 6 therein. The master cylinder housing 7 includes therein a cylinder 70 for the master cylinder 5, a cylinder 71 for the stroke simulator 6, and a plurality of oil passages (fluid passages). The cylinder 70 includes a large-diameter portion 70a and a small-diameter portion 70b. The large-diameter portion 70a is provided at a position closer to the input rod 101 than the small-diameter portion 70b is, and an inner diameter thereof is larger than an inner diameter of the small-diameter portion 70b. An axial line of the large-diameter portion 70a coincides with an axial point of the small-diameter portion 70b (an axial line O). The input rod 101 includes a stopper plate 101a for preventing detachment from the cylinder 70. The plurality of oil passages includes replenishment oil passages 72, supply oil passages 73, and a positive pressure oil passage 74. The master cylinder housing 7 includes a plurality of ports therein, and each of the ports is opened on an outer peripheral surface of the master cylinder housing 7. The plurality of ports includes replenishment ports 75P and 75S, supply ports 76, and a backpressure port 77. The replenishment ports 75P and 75S are connected to replenishment ports 40P and 40S of the reservoir tank 4, respectively. The master cylinder pipes 10M are connected to the supply ports 76, and the backpressure chamber pipe 10X is connected to the backpressure port 77. One end and the other end of each of the replenishment oil passages 72 are connected to the replenishment port 75 and the cylinder 70, respectively.

The master cylinder 5 is connected to the brake pedal 100 via the input rod 101, and generates a master cylinder hydraulic pressure according to an operation performed by the driver on the brake pedal 100. The master cylinder 5 includes pistons 51 axially movable according to the operation on the brake pedal 100. The pistons 51 are contained in the cylinder 70, and define hydraulic chambers 50. The master cylinder 5 is a tandem-type cylinder, and includes, as the pistons 51, a primary piston 51P pushed by the input rod 101 and a secondary piston 51S configured as a free piston. These pistons 51P and 51S are arranged in series. A primary chamber 50P is defined by the pistons 51P and 51S, and a secondary chamber 50S is defined by the secondary piston 51S. One end and the other end of each of the supply oil passages 73 are connected to the hydraulic chamber 50 and the supply port 76, respectively. Each of the hydraulic chambers 50P and 505 is replenished with the brake fluid from the reservoir tank 4, and generates the master cylinder hydraulic pressure by the movement of the above-described piston 51. A coil spring 52P as a return spring is disposed between these pistons 51P and 51S in the primary chamber 50P. A coil spring 52S as a return spring is disposed between a bottom portion of the cylinder 70 and the piston 51S in the secondary chamber 505. Piston seals 541 and 542 are set on an inner periphery of the small-diameter portion 70b of the cylinder 70. The piston seals 541 and 542 are a plurality of seal members that seals between an outer peripheral surface of each of the pistons 51P and 51S and an inner peripheral surface of the small-diameter portion 70b while being in sliding constant with each of the pistons 51P and 51S. Each of the piston seals is a known seal member cup-shaped in cross-section that includes a lip portion on an inner diameter side (a cup seal). Each of the piston seals permits a flow of the brake fluid in one direction and prohibits or reduces a flow of the brake fluid in the other direction with the lip portion in contact with the outer peripheral surface of the piston 51. A first piston seal 541 permits a flow of the brake fluid from the replenishment port 40 toward the primary chamber 50P or the secondary chamber 50S, and prohibits or reduces a flow of the brake fluid in an opposite direction. A second piston seal 542P prohibits or reduces a flow of the brake fluid toward the cylinder large-diameter portion 70a, and a second piston seal 542S prohibits or reduces a flow of the brake fluid toward the primary chamber 50P.

The stroke sensor 94 outputs a sensor signal according to a movement amount (a stroke) of the primary piston 51P. The stroke sensor 94 includes a detection portion 95 and a magnet 96. The detection portion 95 is attached to a left outer peripheral surface of the master cylinder housing 7. The magnet 96 is attached to the primary piston 51P. The detection portion 95 and the magnet 96 are disposed close to each other. The detection portion 95 is a Hall IC including a Hall element. A voltage generally proportional to a value of a magnetic flux density is generated when a certain current is applied to the Hall element. The detection portion 95 outputs a sensor signal having a voltage according to a value of the generated voltage.

The stroke simulator 6 is actuated according to the brake operation performed by the driver, and provides a reaction force and a stroke to the brake pedal 100. The stroke simulator 6 includes a cylinder 60, a piston 61, a positive pressure chamber 601, a backpressure chamber 602, and elastic members (a first spring 64, a second spring 65, and a damper 66). The cylinder 60 is provided separately from the cylinder 70 in the master cylinder housing 7. The cylinder 60 includes a large-diameter portion 60a and a small-diameter portion 60b. The positive pressure chamber 601 and the backpressure chamber 602 are defined by the piston 61 provided at the small-diameter portion 60b of the cylinder 60. The elastic members are provided at the large-diameter portion 60a of the cylinder 60, and bias the piston 61 in a direction for reducing a volume of the positive pressure chamber 601. A bottomed cylindrical retainer member 62 is disposed between the first spring 64 and the second spring 65. One end and the other end of the positive pressure oil passage 74 are connected to a secondary-side supply oil passage 73S and the positive pressure chamber 601, respectively. The brake fluid is delivered from the master cylinder 5 (the secondary chamber 50S) to the positive pressure chamber 601 according to the brake operation performed by the driver, by which the pedal stroke is generated, and the reaction force of the brake operation performed by the driver is also generated due to the biasing forces of the elastic members. The first unit 1A does not include an engine negative-pressure booster that boosts the brake operation force by utilizing an intake negative pressure generated by an engine of the vehicle.

The second unit 1B is provided between the first unit 1A and the brake actuation unit. The second unit 1B is connected to the primary chamber 50P via the primary pipe 10MP, connected to the secondary chamber 50S via the secondary pipe 10MS, connected to the wheel cylinders W/C via the wheel cylinder pipes 10W, and connected to the backpressure chamber 602 via the backpressure chamber pipe 10X. Further, the second unit 1B is connected to the reservoir tank 4 via the intake pipe 10R. The second unit 1B includes a second unit housing 8, a motor 20, a pump 3, a plurality of electromagnetic valves 21 and the like, a plurality of hydraulic pressure sensors 91 and the like, and an electronic control unit 90 (hereinafter referred to as an ECU). The second unit housing 8 is a casing that contains (houses) the pump 3 and valve bodies of the electromagnetic valves 21 and the like therein. The second unit housing 8 includes therein circuits (brake hydraulic circuits) of the above-described two systems (the P system and the S system), through which the brake fluid flows. The circuits of the two systems are formed by a plurality of oil passages. The plurality of oil passages includes supply oil passages 11, an intake oil passage 12, a discharge oil passage 13, a pressure adjustment oil passage 14, pressure reduction oil passages 15, a backpressure oil passage 16, a first simulator oil passage 17, and a second simulator oil passage 18. Further, the second unit housing 8 includes therein a reservoir (an internal reservoir) 120, which is a fluid pool, and a damper 130. A plurality of ports is formed inside the second unit housing 8, and these ports are opened on an outer surface of the second unit housing 8. The plurality of ports includes master cylinder ports 871 (a primary port 871P and a secondary port 871S), an intake port 873, a backpressure port 874, and wheel cylinder ports 872. The primary pipe 10MP is connected to the primary port 871P. The secondary pipe 10MS is connected to the secondary port 871S. The intake pipe 10R is connected to the intake port 873. The backpressure chamber pipe 10X is connected to the backpressure port 874. Each of the wheel cylinder pipes 10W is connected to each of the wheel cylinder ports 872.

The motor 20 is a rotary electric motor, and includes a rotational shaft for driving the pump 3. The motor 20 may be a brushless motor including a rotational number sensor such as a resolver that detects a rotational angle or the number of rotations of the rotational shaft, or may be a brushed motor. The pump 3 introduces therein the brake fluid in the reservoir tank 4 by the rotational driving of the motor 20, and discharges the brake fluid toward the wheel cylinders W/C. In the first embodiment, a plunger pump including five plungers, which is excellent in terms of, for example, a noise and vibration performance, is employed as the pump 3. The pump 3 is used in common by both of the S and P systems. Each of the electromagnetic valves 21 and the like is a solenoid valve that operates according to a control signal, and a valve body thereof is stroked to thus switch opening/closing of the oil passage (establishes or blocks communication through the oil passage) according to power supply to the solenoid. The electromagnetic valves 21 and the like each generate a control hydraulic pressure by controlling a communication state of the above-described circuit to adjust a flow state of the brake fluid. The plurality of electromagnetic valves 21 and the like include shut-off valves 21, pressure increase valves (hereinafter referred to as SOL/V INs) 22, communication valves 23, a pressure adjustment valve 24, pressure reduction valves (hereinafter referred to as SOL/V OUTs) 25, a stroke simulator IN valve (hereinafter referred to as an SS/V IN) 27, and a stroke simulator OUT valve (hereinafter referred to as an SS/V OUT) 28. The shut-off valves 21, the SOL/V INs 22, and the pressure adjustment valve 24 are each a normally opened electromagnetic valve opened when no power is supplied thereto. The communication valves 23, the pressure reduction valves 25, the SS/V IN 27, and the SS/V OUT 28 are each a normally closed electromagnetic valve closed when no power is supplied thereto. The shut-off valves 21, the SOL/V INs 22, and the pressure adjustment valve 24 are each a proportional control valve, an opening degree of which is adjusted according to a current supplied to a solenoid. The communication valves 23, the pressure reduction valves 25, the SS/V IN 27, and the SS/V OUT 28 are each an ON/OFF valve, opening/closing of which is controlled to be switched between two values, i.e., switched to be either opened or closed. The proportional control valve can also be used as these valves. The hydraulic pressure sensors 91 and the like detect a discharge pressure of the pump 3 and the master cylinder hydraulic pressure. The plurality of hydraulic pressure sensors includes a master cylinder hydraulic pressure sensor 91, a discharge pressure sensor 93, and wheel cylinder hydraulic pressure sensors 92 (a primary pressure sensor 92P and a secondary pressure sensor 92S).

In the following description, the brake hydraulic circuit of the second unit 1B will be described with reference to FIG. 1. Members corresponding to the individual wheels FL to RR will be distinguished from one another if necessary, by indices a to d added at the ends of reference numerals thereof, respectively. One end side of the supply oil passage 11P is connected to the primary port 871P. The other end side of the supply oil passage 11P branches off into an oil passage 11a for the front left wheel and an oil passage 11d for the rear right wheel. Each of the oil passages 11a and 11d is connected to the wheel cylinder port 872 corresponding thereto. One end side of the supply oil passage 11S is connected to the secondary port 871S. The other end side of the supply oil passage 11S branches off into an oil passage 11b for the front right wheel and an oil passage 11c for the rear left wheel. Each of the oil passages 11b and 11c is connected to the wheel cylinder port 872 corresponding thereto. The shut-off valves 21 are provided on the above-described one end sides of the supply oil passages 11. The SOL/V IN 22 is provided in each of the oil passages 11 on the above-described other end side. A bypass oil passage 110 is provided in parallel with each of the oil passages 11 while bypassing the SOL/V IN 22, and a check valve 220 is provided in the bypass oil passage 110. The check valve 220 permits only a flow of the brake fluid directed from one side where the wheel cylinder port 872 is located toward the other side where the master cylinder port 871 is located.

The intake oil passage 12 connects the reservoir 120 and an intake port 823 of the pump 3 to each other. One end side of the discharge oil passage 13 is connected to a discharge port 821 of the pump 3. The other end side of the discharge oil passage 13 branches off into an oil passage 13P for the P system and an oil passage 13S for the S system. Each of the oil passages 13P and 13S is connected to a portion of the supply oil passage 11 between the shut-off valve 21 and the SOL/V INs 22. The damper 130 is provided on the above-described one end side of the discharge oil passage 13. The communication valve 23 is provided in each of the oil passages 13P and 13S on the above-described other end side. Each of the oil passages 13P and 13S functions as a communication passage connecting the supply oil passage 11P of the P system and the supply oil passage 11S of the S system to each other. The pump 3 is connected to each of the wheel cylinder ports 872 via the above-described communication passages (the discharge oil passages 13P and 13S) and the supply oil passages 11P and 11S. The pressure adjustment oil passage 14 connects a portion of the discharge oil passage 13 between the damper 130 and the communication valves 23, and the reservoir 120 to each other. The pressure adjustment valve 24 is provided in the pressure adjustment oil passage 14. The pressure reduction oil passage 15 connects a portion of each of the oil passages 11a to 11d of the supply oil passages 11 between the SOL/V IN 22 and the wheel cylinder port 872, and the reservoir 120 to each other. The SOL/V OUT 25 is provided in the pressure reduction oil passage 15.

One end side of the backpressure oil passage 16 is connected to the backpressure port 874. The other end side of the backpressure oil passage 16 branches off into the first simulator oil passage 17 and the second simulator oil passage 18. The first simulator oil passage 17 is connected to a portion of the supply oil passage 11S between the shut-off valve 21S and the SOL/V INs 22b and 22c. The SS/V IN 27 is provided in the first simulator oil passage 17. A bypass oil passage 170 is provided in parallel with the first simulator oil passage 17 while bypassing the SS/V IN 27, and a check valve 270 is provided in the bypass oil passage 170. The check valve 270 permits only a flow of the brake fluid directed from one side where the backpressure oil passage 16 is located toward the other side where the supply oil passage 11S is located. The second simulator oil passage 18 is connected to the reservoir 120. The SS/V OUT 28 is provided in the second simulator oil passage 18. A bypass oil passage 180 is provided in parallel with the second simulator oil passage 18 while bypassing the SS/V OUT 28, and a check valve 280 is provided in the bypass oil passage 180. The check valve 280 permits only a flow of the brake fluid directed from one side where the reservoir 120 is located toward the other side where the backpressure oil passage 16 is located.

The hydraulic pressure sensor 91 is provided between the shut-off valve 21S and the secondary port 871S in the supply oil passage 11S. The hydraulic pressure sensor 91 detects a hydraulic pressure at this portion (a hydraulic pressure in the positive pressure chamber 601 of the stroke simulator 6, or the master cylinder hydraulic pressure). The hydraulic pressure sensors 92 are provided between the shut-off valves 21 and the SOL/V INs 22 in the first oil passages 11. The hydraulic pressure sensors 92 detect hydraulic pressures at these portions (corresponding to the wheel cylinder hydraulic pressures). The hydraulic pressure sensor 93 is provided between the damper 130 and the communication valves 23 in the discharge oil passage 13. The hydraulic pressure sensor 93 detects a hydraulic pressure at this portion (the discharge pressure of the pump).

Hereinafter, a three-dimensional orthogonal coordinate system having an X axis, a Y axis, and a Z axis is set for convenience of the description. A Z-axis direction is defined to be a vertical direction and a Z-axis positive direction is defined to be an upper side in the vertical direction with the first unit 1A and the second unit 1B mounted on the vehicle. An X-axis direction is defined to be a longitudinal direction of the vehicle and an X-axis positive direction is defined to be a front side of the vehicle. A Y-axis direction is defined to be a lateral direction of the vehicle.

In the first unit 1A, the input rod 101 extends from an end on an X-axis negative direction side that is connected to the brake pedal 100 toward the X-axis positive direction side. A rectangular plate-like flange portion 78 is provided at an end of the master cylinder housing 7 on the X-axis negative direction side. A bolt hole is formed at each of four corners of the flange portion 78. A bolt B1 penetrates through the bolt hole. The bolt B1 is used to fix and attach the first unit 1A to a dash panel on a vehicle body side. The reservoir tank 4 is set on a Z-axis positive direction side of the master cylinder housing 7.

In the second unit 1B, the second unit housing 8 is a generally cuboidal block formed with use of aluminum alloy as a material thereof. The second unit housing 8 is fixed to the vehicle body side (a bottom surface of the motor room) via a not-illustrated insulator and mount. The motor 20 is disposed and a motor housing 200 is attached on a left side surface 801 of the second unit housing 8. The ECU 90 is attached on a right side surface of the second unit housing 8. In other words, the ECU 90 is provided integrally with the second unit housing 8. The ECU 90 includes a not-illustrated control board and control unit housing (case) 901. The control board controls states of power supply to the motor 20 and the solenoids of the electromagnetic valves 21 and the like. Various kinds of sensors that detect a motion state of the vehicle, such as an acceleration sensor that detects an acceleration of the vehicle, and an angular speed sensor that detects an angular speed (a yaw rate) of the vehicle, may be mounted on the control board. Further, a combination sensor (a combined sensor) formed by unitizing these sensors may be mounted on the control board. The control board is contained in the case 901. The case 901 is a cover member fastened and fixed to a back surface of the second unit housing 8 with use of bolts.

The case 901 is a cover member made from synthetic resin. The case 901 includes a board containing portion 902 and a connector portion 903. The board containing portion 902 contains therein the control board and parts of the solenoids of the electromagnetic valves 21 and the like. The connector portion 903 protrudes toward a Y-axis positive direction side beyond the board containing portion 902. As viewed from the X-axis direction, a terminal of the connector portion 903 is exposed toward the Y-axis positive direction side, and also extends toward a Y-axis negative direction side to be connected to the control board. Each terminal of the connector portion 903 (which is exposed toward the Y-axis positive direction side) is connectable to an external apparatus or the stroke sensor 94 (hereinafter referred to as the external apparatus and the like). An electric connection is established between the external apparatus and the like and the control board (the ECU 90) by insertion of another connector connected to the external apparatus and the like into the connector portion 903 from the Y-axis positive direction side. Further, power is supplied from an external power source (a battery) to the control board via the connector portion 903. A conductive member functions as a connection portion that electrically connects the control board and the motor 20 to each other, and power is supplied from the control board to the motor 20 via the conductive member.

In the first embodiment, the electromagnetic valves and the like are not provided in the first unit 1A, and the SS/V IN 27 and the SS/V OUT 28, which switch the actuation of the stroke simulator 6, are provided in the second unit 1B. Due to this configuration, the present embodiment does not require a controller for driving the electromagnetic valves in the first unit 1A. Further, the present embodiment does not require a wiring for controlling the electromagnetic valves between the first unit 1A and the second unit 1B. Therefore, the present embodiment can reduce the cost. Further, when the stroke simulator 6 in the first unit 1A and the second unit 1B are connected via the pipe, they are only connected via the backpressure chamber 602 and the backpressure chamber pipe 10X with no connection established between the positive pressure chamber 601 of the stroke simulator 6 and the second unit 1B. Therefore, the present embodiment allows the actuation of the stroke simulator 6 to be switched without providing a plurality of pipes, thereby succeeding in reducing the cost.

Information input to the ECU 90 includes detection values of the stroke sensor 94 and the hydraulic pressure sensors 91 and the like, and information regarding a running state that is transmitted from the vehicle side. The ECU 90 controls the wheel cylinder hydraulic pressure of each of the wheels FL to RR by actuating the electromagnetic valves 21 and the like and the motor 20 with use of the input information according to a built-in program. By this control, the ECU 90 can perform various kinds of brake control (anti-lock brake control for preventing or reducing a slip of the wheel due to the braking, boosting control for reducing a required driver's brake operation force, brake control for controlling the motion of the vehicle, automatic brake control such as adaptive cruise control, regenerative cooperative brake control, and the like). The control of the motion of the vehicle includes vehicle behavior stabilization control such as electronic stability control. In the regenerative cooperative brake control, the ECU 90 controls the wheel cylinder hydraulic pressures so as to achieve a target deceleration (a target braking force) in cooperation with regenerative brake.

The ECU 90 includes a brake operation amount detection portion 90a, a target wheel cylinder hydraulic pressure calculation portion 90b, a boosting control portion 90c, a sudden brake operation state determination portion 90d, and a second pressing force brake creation portion 90e, as a configuration for performing the above-described brake control. The brake operation amount detection portion 90a detects a stroke (a movement amount) of the input rod 101 in response to the sensor signal from the stroke sensor 94. The target wheel cylinder hydraulic pressure calculation portion 90b calculates a target wheel cylinder hydraulic pressure. More specifically, the target wheel cylinder hydraulic pressure calculation portion 90b calculates, based on the detected pedal stroke, the target wheel cylinder hydraulic pressure that realizes a predetermined boosting rate, i.e., an ideal characteristic of a relationship between the pedal stroke and a brake hydraulic pressure requested by the driver (a vehicle deceleration G requested by the driver). Further, at the time of the regenerative cooperative brake control, the target wheel cylinder hydraulic pressure calculation portion 90b calculates the target wheel cylinder hydraulic pressure in relation to the regenerative braking force. For example, the target wheel cylinder hydraulic pressure calculation portion 90b calculates such a target wheel cylinder hydraulic pressure that a sum of the regenerative braking force input from a control unit of the regenerative braking apparatus and a hydraulic braking force corresponding to the target wheel cylinder hydraulic pressure can satisfy the vehicle deceleration requested by the driver. At the time of the motion control, the target wheel cylinder hydraulic pressure calculation portion 90b calculates the target wheel cylinder hydraulic pressure for each of the wheels FL to RR so as to realize a desired vehicle motion state based on, for example, a detected vehicle motion state amount (the lateral acceleration or the like).

The boosting control portion 90c actuates the pump 3, and controls the shut-off valves 21 and the communication valves 23 in closing directions and opening directions, respectively, at the time of the brake operation performed by the driver. By this activation and control, the boosting control portion 90c creates higher wheel cylinder hydraulic pressures than the master cylinder hydraulic pressure with use of the discharge pressure of the pump 3 as a hydraulic pressure source, thereby allowing the brake system to perform the boosting control that generates a hydraulic braking force by which the driver's braking operation force falls short. More specifically, the boosting control portion 90c realizes the target wheel cylinder hydraulic pressure by controlling the pressure adjustment valve 24 while keeping the pump 3 actuated at a predetermined number of rotations to thus adjust the brake fluid amount to be supplied from the pump 3 to the wheel cylinders W/C. The brake system according to the first embodiment exerts a boosting function that assists the brake operation force by actuating the pump 3 of the second unit 1B instead of the engine negative pressure booster. Further, the boosting control portion 90c controls the SS/V IN 27 and the SS/V OUT 28 in a closing direction and an opening direction, respectively. By this control, the boosting control portion 90c causes the stroke simulator 6 to function.

The sudden brake operation state determination portion 90d detects a brake operation state based on an input from the brake operation amount detection portion 90a and the like, and determines (detects) whether the brake operation state is a predetermined sudden brake operation state. For example, the sudden brake operation state determination portion 90d determines whether an amount of a change in the pedal stroke per unit time exceeds a predetermined threshold value. When the brake operation state is determined to be the sudden brake operation state, the ECU 90 switches control from the creation of the wheel cylinder hydraulic pressures by the boosting control portion 90c to the creation of the wheel cylinder hydraulic pressures by the second pressing force brake creation portion 90e. The second pressing force brake creation portion 90e actuates the pump 3, and controls the shut-off valves 21, the SS/V IN 27, and the SS/V OUT 28 in the closing directions, an opening direction, and a closing direction, respectively. By this activation and control, the second pressing force brake creation portion 90e realizes second pressing force brake that creates the wheel cylinder hydraulic pressures with use of the brake fluid transmitted out of the backpressure chamber 602 of the stroke simulator 6 until the pump 3 is ready to generate sufficiently high wheel cylinder pressures. The second pressing force brake creation portion 90e may control the shut-off valves 21 in opening directions. Further, the second pressing force brake creation portion 90e may control the SS/V IN 27 in the closing direction, and, in this case, the brake fluid from the backpressure chamber 602 is supplied to the wheel cylinder W/C side via the check valve 270 (brought into a opened state because the pressure in the wheel cylinder W/C side is still lower than the backpressure chamber 602 side). In the first embodiment, the brake fluid can be efficiently supplied from the backpressure chamber 602 side to the wheel cylinder W/C side by controlling the SS/V IN 27 in the opening direction. After that, when the brake operation state stops being determined to be the sudden brake operation state or a predetermined condition indicating that a discharge capacity of the pump 3 becomes sufficient is satisfied, the ECU 90 switches the control from the creation of the wheel cylinder hydraulic pressures by the second pressing force brake creation portion 90e to the creation of the wheel cylinder hydraulic pressures by the boosting control portion 90c. The boosting control portion 90c controls the SS/V IN 27 and the SS/V OUT 28 in the closing direction and the opening direction, respectively. By this control, the boosting control portion 90c causes the stroke simulator 6 to function. The ECU 90 may operate so as to switch the control to the regenerative cooperative brake control after the second pressing force brake.

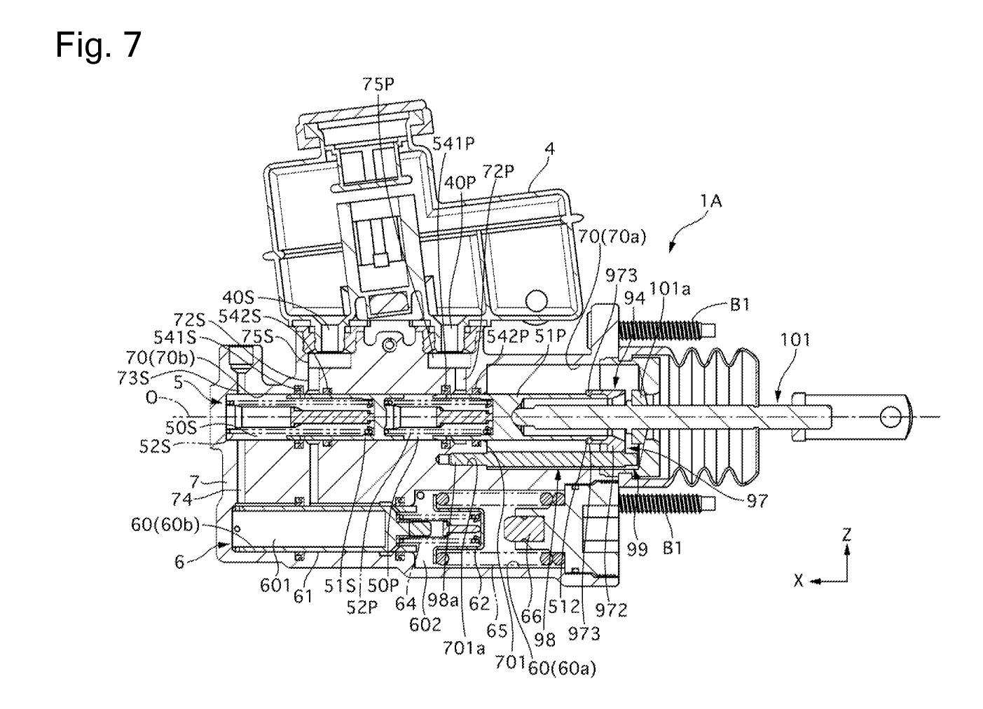

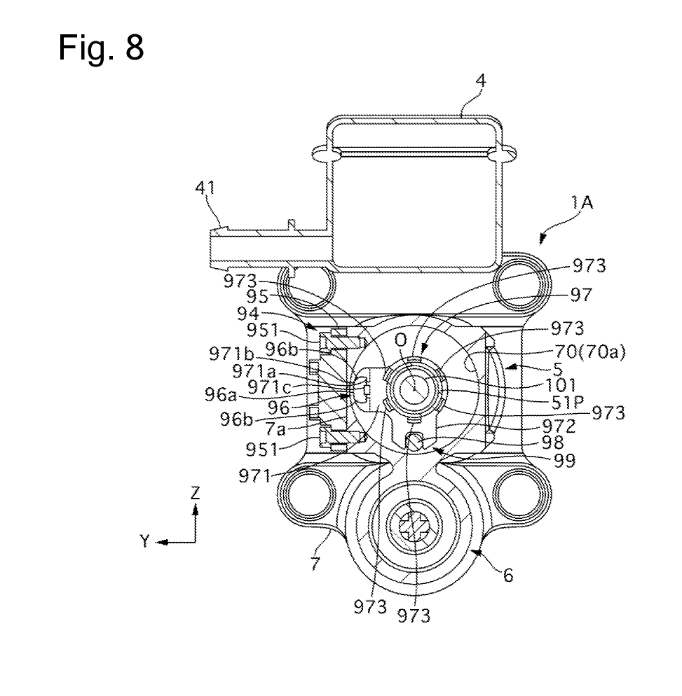

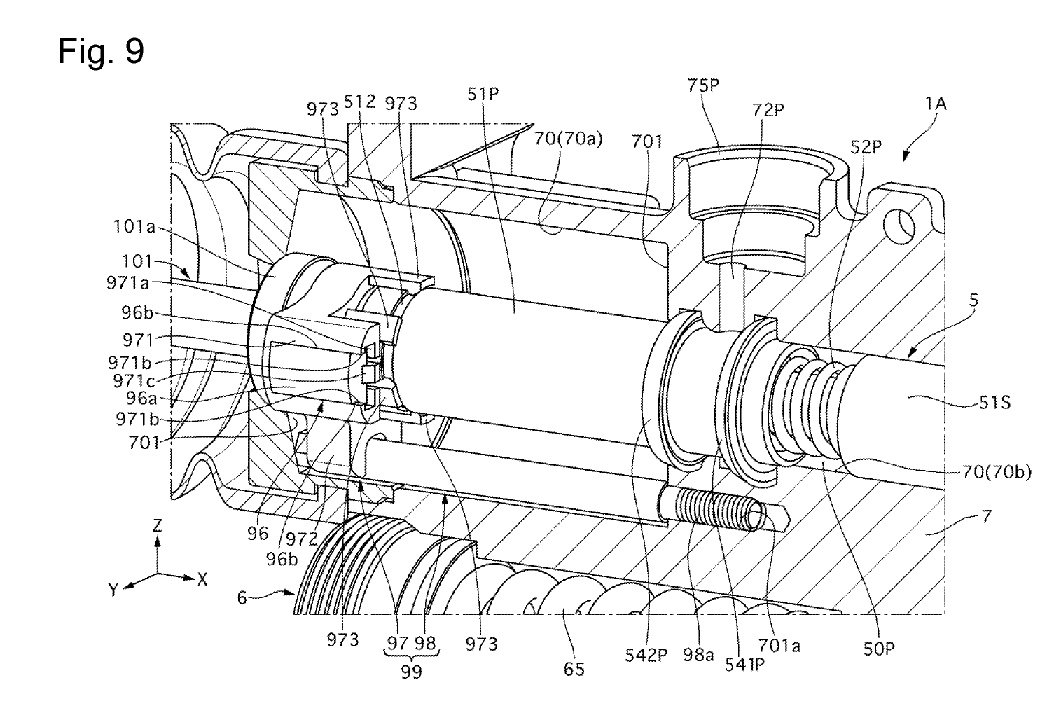

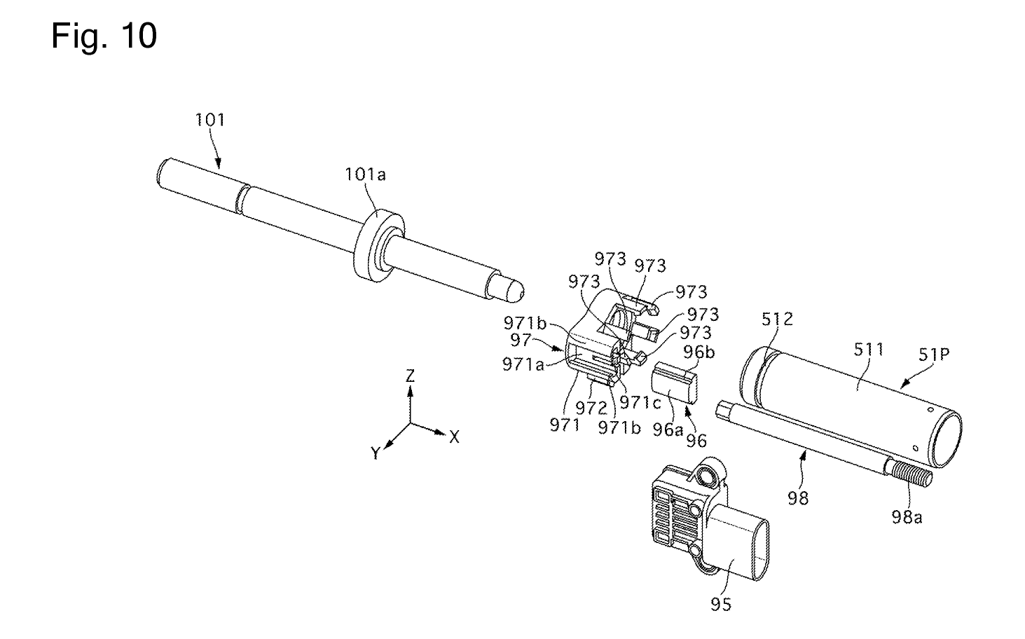

Next, a configuration of the stroke sensor 94 according to the first embodiment will be described in detail with reference to FIGS. 7 to 10. FIG. 7 is a cross-sectional view taken along a line S7-S7 illustrated in FIG. 5. FIG. 8 is a cross-sectional view of the first embodiment taken along a line S8-S8 illustrated in FIG. 4. FIG. 9 is a partial cross-sectional perspective view of the master cylinder 5 according to the first embodiment. FIG. 10 is an exploded perspective view of the stroke sensor 94 according to the first embodiment.

The detection portion 95 of the stroke sensor 94 is fixed to an outer peripheral surface (a left outer peripheral surface) 7a of the master cylinder housing 7 on the Y-axis positive direction side with use of two screws 951. The outer peripheral surface 7a on the Y-axis positive direction side is located on an outer periphery of the large-diameter portion 70a, and positioned on the Y-axis positive direction side (the left side) of the large-diameter portion 70a. The outer peripheral surface 7a on the Y-axis positive direction side extends in parallel with the Z axis. A central position of the detection portion 95 in the Z-axis direction coincides with a position of the axial line O of the cylinder 70 (the large-diameter portion 70a and the small-diameter portion 70b) in the Z-axis direction. Because the direction of the axial line O coincides with the X-axis direction, hereinafter, the direction of the axial line O will also be referred to as the X-axis direction (or simply an axial direction). Further, a direction extending around the axial line O will be referred to as a circumferential direction, and a direction radially extending from the axial line O will be referred to as a radial direction.

The magnet 96 of the stroke sensor 94 is, for example, a neodymium magnet, and is generally semi-cylindrical in vertical cross section. A width of the magnet 96 (a length in the Z-axis direction) is shorter than a diameter of the primary piston 51P. In other words, the magnet 96 exists partially in the circumferential direction of the primary piston 51P. An outer peripheral portion 96a of the magnet 96 that faces the detection portion 95 has a circular arc shape centered at the same axial line O as the primary piston 51P and slightly smaller in radius than the large-diameter portion 70a of the cylinder 70. A first engaged recess portion 96b extending in the X-axis direction is provided at each of positions in vicinity of both ends of the outer peripheral portion 96a in the Z-axis direction. The magnet 96 is attached at a position in vicinity of an end of the primary piston 51P in the X-axis negative direction via a magnet holder (an engaged member) 97.

The magnet holder 97 is a generally cylindrical member made from synthetic resin, and the primary piston 51P penetrates through an inner peripheral side of the magnet holder 97. The magnet holder 97 is rotatable relative to the primary piston 51P. The magnet holder 97 includes a magnet holding portion 971 and a two-surface width portion (an engaged portion) 972. The magnet holding portion 971 protrudes from an end of the magnet holder 97 in the Y-axis positive direction toward the Y-axis positive direction side. A length from the axial line O to an end of the magnet holding portion 971 in the Y-axis positive direction is shorter than an inner diameter of the large-diameter portion 70a. In other words, the magnet holding portion 971 is out of contact with an inner peripheral surface of the large-diameter portion 70a. The magnet holding portion 971 includes a recessed magnet attachment portion 971a. The magnet attachment portion 971a is shaped so as to conform with an outer shape of the magnet 96. Ends of the magnet attachment portion 971a in the X-axis positive direction and the Y-axis positive direction are opened. Two first engagement claws 971b are provided at an opening edge on the end side of the magnet attachment portion 971a in the Y-axis positive direction. Both the first engagement claws 971b are disposed opposite from each other in the Z-axis direction. Further, one first engagement claw 971c is provided at an opening edge on the end side of the magnet attachment portion 971a in the X-axis positive direction. Each of the first engagement claws 971b is engaged with each of the first engaged recess portions 96b of the magnet 96 in the Y-axis direction when the magnet 96 is attached to the magnet attachment portion 971a. Further, the first engagement claw 971c is engaged in the X-axis direction with an end surface of the magnet 96 in the X-axis positive direction when the magnet 96 is attached to the magnet attachment portion 971a. The magnet 96 is prevented from being detached off from the magnet attachment portion 971a due to each of the first engagement claws 971b and 971c. When the magnet 96 is attached to the magnet holder 97, a central position of the magnet 96 in the Z-axis direction coincides with the position of the axial line O in the Z-axis direction.

The two-surface width portion 972 protrudes from an end of the magnet holder 97 in the Z-axis negative direction toward the Z-axis negative direction side. The two-surface width portion 972 includes two flat surfaces that face each other in the Z-axis direction and extend in parallel with each other. A length from the axial line O to an end of the two-surface width portion 972 in the Z-axis negative direction is shorter than the inner diameter of the large-diameter portion 70a. In other words, the two-surface width portion 972 is out of contact with the inner peripheral surface of the large-diameter portion 70a. A guide pin 98 is disposed between the two flat surfaces of the two-surface width portion 972. The guide pin 98 is a metallic rod, and is located on the Z-axis negative direction side with respect to the primary piston 51P and disposed in such a manner that a longitudinal direction thereof extends along the X-axis direction. An end side of the guide pin 98 in the X-axis positive direction is supported in a cantilevered manner on an end surface 701 of the large-diameter portion 70a in the X-axis positive direction. The guide pin 98 includes a male screw portion 98a at the end thereof in the X-axis positive direction. The male screw portion 98a is threadably engaged with a female screw portion 701a formed on the end surface 701 in the X-axis positive direction. When the primary piston 51P is stroked, the two flat surfaces of the two-surface width portion 972 are in sliding contact with the guide pin 98. The guide pin 98 has a length (a dimension in the X-axis direction) that allows it to constantly extend between the two flat surfaces of the two-surface width portion 972 in an entire range of the stroke of the primary piston 51P. In other words, the guide pin 89 is fitted to the two-surface width portion 972 in the circumferential direction, which contributes to restricting a movement of the magnet holder 97 relative to the master cylinder housing 7 in the circumferential direction.

The magnet holder 97 includes a plurality of second engagement claws 973, which protrudes toward the X-axis positive direction side. Each of the second engagement claws 973 is provided per predetermined interval in the circumferential direction. Each of the second engagement claws 973 is disposed so as to be oriented toward the axial line O. Each of the second engagement claws 973 is engaged in the X-axis direction with an annular second engaged recess portion 512 formed at an outer peripheral portion 511 of the primary piston 51P. The second engaged recess portion 512 is provided at a position in vicinity of the end of the primary piston 51P in the X-axis negative direction. A movement of the magnet holder 97 relative to the primary piston 51P in the X-axis direction is restricted by the engagement between the second engagement claws 973 and the second engaged recess portion 512 in the X-axis direction. In the first embodiment, a rotation restriction mechanism 99, which restricts a movement of the magnet 96 in the circumferential direction, is formed by the magnet holder 97 and the guide pin 98.

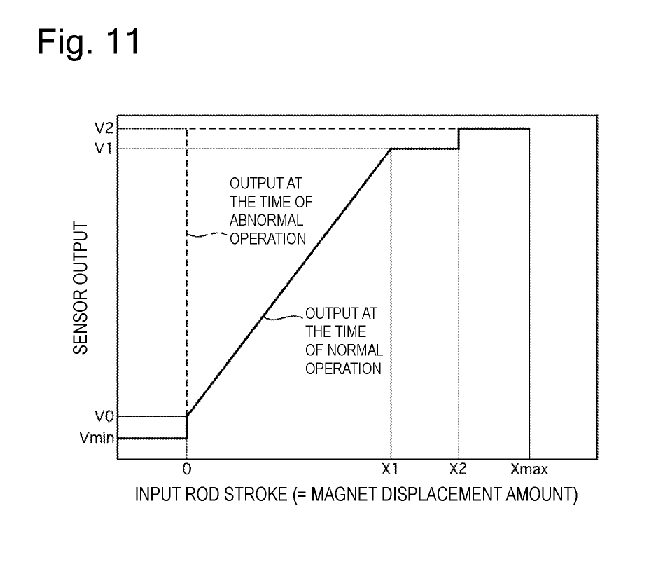

In the brake system according to the first embodiment, the primary piston 51P is stroked in the X-axis positive direction by being pushed by the input rod 101 when the driver steps on the brake pedal 100. At this time, the movement of the magnet holder 97 relative to the primary piston 51P in the X-axis direction is restricted by the fitted engagement between the second engagement claws 973 and the second engaged recess portion 512 in the X-axis direction. Therefore, the magnet holder 97 and the magnet 96 attached to the magnet holder 97 are displaced integrally with the primary piston 51P. The detection portion 95 outputs a sensor signal having a voltage proportional to an amount of the displacement of the magnet 96. FIG. 11 illustrates one example of a relationship between the input rod stroke and the sensor output of the stroke sensor 94 with a solid line. The sensor output has a range of Vmin to V2. However, an actually used region is a range of V0 to V1, and the sensor output is linearly changed in a range of 0 to X1, which corresponds to normal use of the input rod stroke. In a range of X1 to X2, in which the input rod stroke indicates a failure state possible to occur in view of the system, the stroke sensor 94 outputs a constant sensor output (V1) and outputs a limit value (V2) when the input rod stroke exceeds the range corresponding to the failure state. This allows a failure in the stroke sensor 94 and a failure in the pedal or the like to be distinguished from each other when a failure has occurred in the brake system. The brake operation amount detection portion 90a can detect the stroke of the input rod 101 from the sensor output of the stroke sensor 94 by storing the relationship between the sensor output and the input rod stroke indicated by the solid line in FIG. 11 in advance.

Now, the primary piston 51P is rotated when receiving a circumferential force because of a lack of provision for restricting a rotation thereof in the circumferential direction. For example, the coil spring 52P, which biases the primary piston 51P, is twisted when being extended/compressed, so that the primary piston 51P may be rotated when the coil spring 52P is extended/compressed. At this time, in the first embodiment, the two-surface width portion 972 of the magnet holder 97 and the guide pin 98 are fitted to each other in the circumferential direction (a rotational direction), by which the rotation of the magnet holder 97 is restricted (the rotation is prohibited). Therefore, even when the primary piston 51P is rotated, the magnet holder 97 is prevented from being rotated together thereby. Due to this effect, the magnet 96 is stroked while constantly maintaining a shortest radial distance to the detection portion 95.

The conventional brake system includes the annular magnet attached to the outer periphery of the primary piston, and detects the primary stroke of the piston with use of the detection portion fixed to the master cylinder housing. Therefore, even if the magnet is rotated together with the rotation of the primary piston, this does not affect the accuracy of the detection of the input rod stroke because the radial distance between the magnet and the detection portion is kept unchanged. On the other hand, the material of the magnet (for example, neodymium) is expensive, and therefore the use of the annular magnet leads to an increase in the manufacturing cost. Therefore, one conceivable measure is to provide the magnet partially in the circumferential direction of the primary piston from the viewpoint of reducing the manufacturing cost, but, in this case, the radial distance between the magnet and the detection portion increases when the magnet is rotated together with the primary piston. The separation between the magnet and the detection portion makes it impossible for the detection portion to sense the magnetic flux, thereby leading to an abnormal sensor output since when the input rod stroke is 0, for example, as indicated by a broken line in FIG. 11, thus resulting in a reduction in the accuracy of the detection of the input rod stroke.

On the other hand, in the first embodiment, the rotation restriction mechanism 99 (the magnet holder 97 and the guide pin 98) is provided as a rotation prohibition structure that restricts the rotation of the magnet 96, and therefore the radial distance between the magnet 96 and the detection portion 95 can be kept at a predetermined distance (the shortest distance). Due to this effect, the relationship between the input rod stroke and the sensor output is kept at a relationship that would be established when the stroke simulator 94 is normal, which is indicated by the solid line in FIG. 11, and therefore the input rod stroke can be accurately detected. As a result, the present embodiment can accurately detect the stroke of the primary piston 51P (=the input rod stroke) while reducing the manufacturing cost by providing the magnet 96 partially in the circumferential direction of the primary piston 51P.

The first embodiment brings about the following advantageous effects.

(1) The brake apparatus includes the master cylinder housing 7 including the cylinder 70 therein, the primary piston 51P provided inside the cylinder 70 and movable in the axial direction, when the axial direction is the direction of the axial line O of the cylinder 70, the magnet 96 provided, inside the cylinder 70, partially in the circumferential direction of primary the piston 51P, when the circumferential direction is the direction around the axial line O, and configured to be displaced according to the movement of the primary piston 51P, the detection portion 95 provided on the master cylinder housing 7 and configured to detect the stroke of the primary piston, and the rotation restriction mechanism 99 provided inside the cylinder 70 and configured to restrict the movement of the magnet 96 in the circumferential direction.

Therefore, the first embodiment allows the brake apparatus to accurately detect the stroke of the primary piston 51P while reducing the manufacturing cost.

(2) The rotation restriction mechanism 99 includes the magnet holder 97 attached to the primary piston 51P so as to be restricted regarding the movement in the axial direction and permitted to move in the circumferential direction. The magnet holder 97 includes the two-surface width portion 972 configured in such a manner that the movement thereof relative to the master cylinder housing 7 in the circumferential direction is restricted.

Therefore, the first embodiment allows the structure for prohibiting the rotation of the magnet 96 to be easily formed by a different member from the primary piston 51P. Especially, in the first embodiment, the magnet holder 97 is made from synthetic resin, and therefore can be easily molded. Further, the magnet holder 97 does not prevent the rotation of the primary piston 51P, and therefore the first embodiment can prevent or cut down an increase in sliding resistance between the primary piston 51P and the piston seals 541 and 542, an increase in the operation reaction force of the brake pedal 100, and the like.

(3) The rotation restriction mechanism 99 includes the guide pin 98. The one end side of the guide pin 98 in the axial direction is fixed to the master cylinder housing 7, and the other end side of the guide pin 98 in the axial direction is fitted to the two-surface width portion 972 in the circumferential direction.

Therefore, the first embodiment allows the brake apparatus to reliably prohibit the rotation of the magnet holder 97 due to the fitted engagement between the two-surface width portion 972 and the guide pin 98. Further, the guide pin 98 can be formed by fixing one end of the metallic rod to the master cylinder housing 7, and therefore the first embodiment can reduce processing cost compared to forming the guide pin 98 by processing the master cylinder housing 7.

(4) The magnet 96 is provided on the magnet holder 97. The outer peripheral portion 96a of the magnet 96 on the outer side in the radial direction is shaped so as to conform with the large-diameter portion 70a of the cylinder 70, when the radial direction is the direction radially extending from the axial line.

Therefore, even if the magnet 96 is slightly rotated, the brake apparatus can accurately detect the movement amount of the primary piston 51P because the radial distance between the magnet 96 and the detection portion 95 is kept unchanged.

(5) The magnet holder 97 includes the first engagement claws 971b and 971c configured to hold the magnet 96.

Therefore, the first embodiment allows the magnet 96 and the magnet holder 97 to be easily joined to each other by so-called snap-fit without use of a mechanical element such as a screw and an adhesive. As a result, the first embodiment can reduce cost of components and the number of assembling processes.

(6) The primary piston 51P includes the second engaged recess portion 512. The magnet holder 97 includes the second engagement claws 973 configured to be engaged with the second engaged recess portion 512 in the axial direction.

Therefore, the first embodiment allows the magnet holder 97 to be easily attached to the primary piston 51P without use of a mechanical element such as a screw and an adhesive. Further, the first embodiment can realize the structure for attaching the magnet holder 97 to the primary piston 51P so as to restrict the movement thereof in the axial direction and permit the movement thereof in the circumferential direction, with a simple configuration.

(7) The master cylinder housing 7 includes the female screw portion 701a. The guide pin 98 includes the male screw portion 98a on the one end side. The male screw portion 98a is threadably engaged with the female screw portion 701a.

Therefore, the first embodiment allows the guide pin 98 to be reliably and easily fixed to the master cylinder housing 7. Further, the first embodiment can prevent or reduce deformation of the master cylinder housing 7 compared to press-fitting the one end side of the guide pin 98 in a hole formed at the master cylinder housing 7.

(8) The guide pin 98 is provided on the lower side in the direction of gravitational force with respect to the primary piston 51P with the brake apparatus mounted on the vehicle. The detection portion 95 is provided at the side of the master cylinder housing 7 with the brake apparatus mounted on the vehicle.

The magnet 96 and the guide pin 98 should be positioned offset from each other in the circumferential direction to avoid interference therebetween on the outer periphery of the primary piston 51P. Disposing the guide pin 98 on the lower side with respect to the primary piston 51P allows the magnet 96 to be disposed on any of the left side and the right side of the primary piston 51P. As a result, the first embodiment can improve flexibility of a layout variation of the detection portion 95 disposed so as to face the magnet 96.

(9) The brake system includes the master cylinder 5, the first unit 1A, and the second unit 1B. The master cylinder 5 includes the master cylinder housing 7 including the cylinder 70 therein, the primary piston 51P provided inside the cylinder 70 and movable in the axil direction, when the axial direction is the direction of the axial line O of the cylinder 70, the magnet 96 provided, inside the cylinder 70, partially in the circumferential direction of the primary piston 51P, when the circumferential direction is the direction around the axial line, and configured to be displaced according to the movement of the primary piston 51P, and the rotation restriction mechanism 99 provided inside the cylinder 70 and configured to restrict the movement of the magnet 96 in the circumferential direction. The first unit 1A includes the detection portion 95 provided at the master cylinder 5 and configured to detect the movement amount of the primary piston 51P, and the stroke simulator 6 configured in such a manner that the brake fluid flowing out from the master cylinder 5 is introduced therein. The stroke simulator 6 is configured to generate the simulated operation reaction force of the brake pedal 100. The second unit 1B includes the second unit housing 8 connected to the first unit 1A and including the oil passages therein, and the pump 3 provided inside the second unit housing 8 and configured to generate the hydraulic pressures in the wheel cylinders W/C mounted at the wheels FL to RR via the oil passages.

Therefore, the first embodiment allows the brake apparatus to accurately detect the stroke of the primary piston 51P while reducing the manufacturing cost.

(10) The master cylinder 5 forms the brake apparatus and is configured to generate the brake hydraulic pressures by the brake operation. The master cylinder 5 includes the master cylinder housing 7 including the cylinder 70 therein, the primary piston 51P provided inside the cylinder 70 and movable in the axial direction, when the axial direction is the direction of the axial line O of the cylinder 70, the magnet 96 provided, inside the cylinder 70, partially in the circumferential direction of the primary piston 51P, when the circumferential direction is the direction around the axial line, and configured to be displaced according to the movement of the primary piston 51P, and the rotation restriction mechanism 99 provided inside the cylinder 70 and configured to restrict the movement of the magnet 96 in the circumferential direction.

Therefore, the first embodiment allows the brake apparatus to accurately detect the stroke of the primary piston 51P while reducing the manufacturing cost.

### Second Embodiment

Next, a second embodiment will be described. The second embodiment has a basic configuration similar to the first embodiment, and therefore will be described focusing on only differences therefrom.

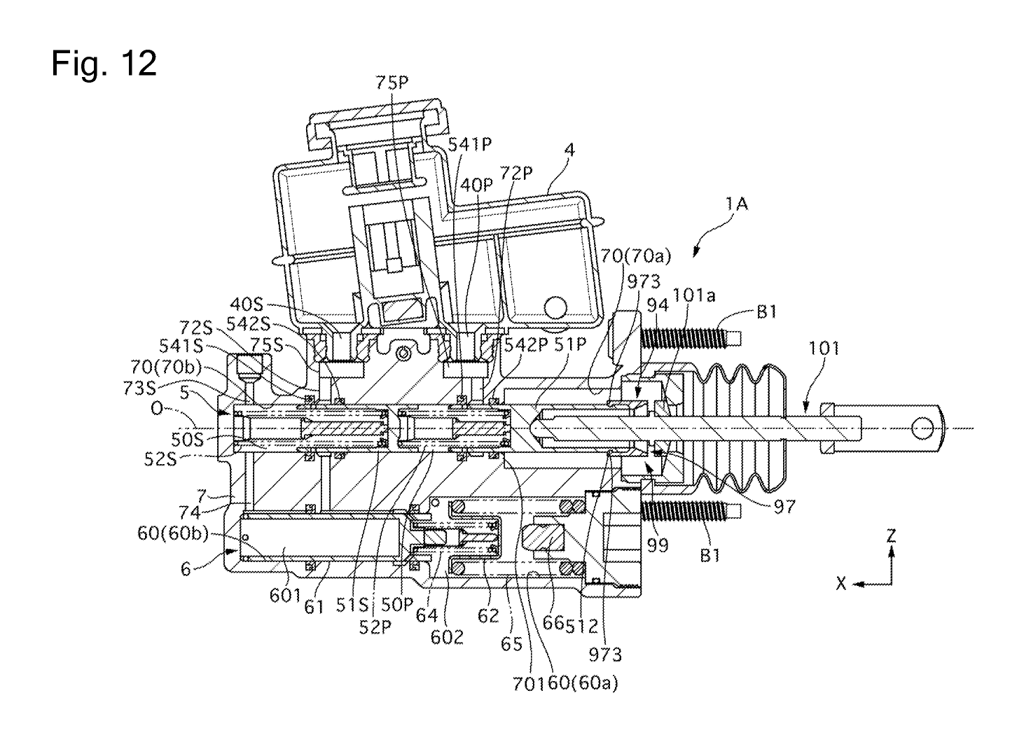

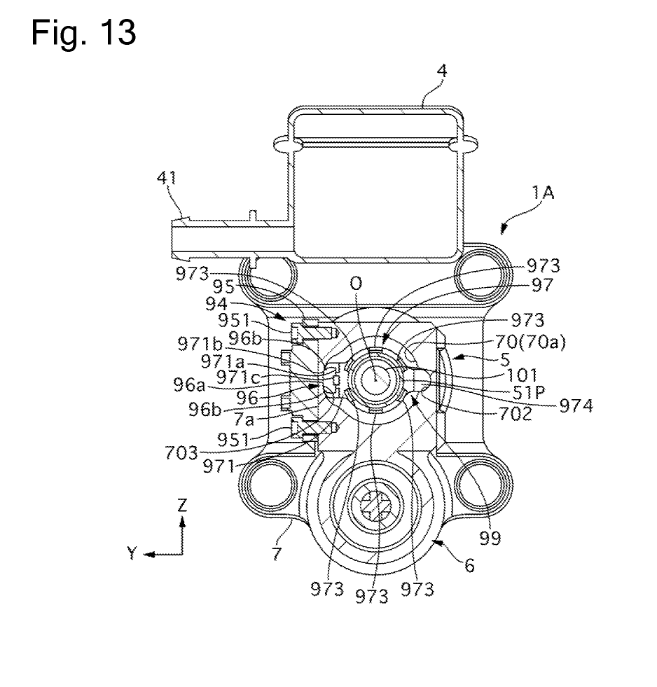

FIG. 12 is a cross-sectional view of the second embodiment taken along the line S7-S7 illustrated in FIG. 5. FIG. 13 is a cross-sectional view of the second embodiment taken along the line S8-S8 illustrated in FIG. 4.

The magnet holder 97 according to the second embodiment includes the magnet holding portion 971 and a protruding portion (the engaged portion) 974. The protruding portion 974 protrudes from the end of the magnet holder 97 in the Y-axis negative direction toward the Y-axis negative direction side. A distal end of the protruding portion 974 (an end in the Y-axis negative direction) is semi-spherical. A central position of the protruding portion 974 in the Z-axis direction coincides with the position of the axial line O of the cylinder 70 in the Z-axis direction. The inner diameter of the large-diameter portion 70a is shorter than a length from the axial line O to the end of the magnet holding portion 971 in the Y-axis positive direction and a length from the axial line O to the end of the protruding portion 974 in the Y-axis negative direction. An engagement groove 702 is formed on the large-diameter portion 70a at a position that faces the protruding portion 974. The engagement groove 702 is fitted with the protruding portion 974 in the circumferential direction. As viewed from the X-axis direction, the engagement groove 702 is shaped so as to conform with a shape of the protruding portion 974, and is in abutment with the protruding portion 974. The engagement groove 702 extends in the X-axis direction, and has a length (a dimension in the X-axis direction) that allows it to be constantly engaged with the protruding portion 974 in the circumferential direction in the entire range of the stroke of the primary piston 51P. This configuration contributes to restricting the movement of the magnet holder 97 relative to the master cylinder housing 7 in the circumferential direction. In the second embodiment, the rotation restriction mechanism 99, which restricts the movement of the magnet 96 in the circumferential direction, is formed by the magnet holder 97 and the engagement groove 702.

A groove portion 703 is formed on the large-diameter portion 70a at a position that faces the magnet holding portion 971. The groove 703 extends in the X-axis direction, and has the same length (dimension in the X-axis direction) as the engagement groove 702. As viewed from the X-axis direction, the groove portion 703 is shaped so as to conform with a shape of the magnet holding portion 971. The magnet holding portion 971 is out of contact with an inner peripheral surface of the groove portion 703.

In the second embodiment, the rotation restriction mechanism 99 (the magnet holder 97 and the protruding portion 974) is provided as the rotation prohibition structure that restricts the rotation of the magnet 96, and thus the radial distance between the magnet 96 and the detection portion 95 can be kept at the predetermined distance (the shortest distance). Due to this effect, the input rod stroke can be accurately detected.

The second embodiment brings about the following advantageous effects.

(11) The rotation restriction mechanism 99 includes the engagement groove 702 provided on the inner peripheral surface of the cylinder 70 and configured to be fitted with the protruding portion 974 in the circumferential direction.

Therefore, the second embodiment allows the brake apparatus to reliably prohibit the rotation of the magnet holder 97 due to the fitted engagement between the protruding portion 974 and the engagement groove 702. Further, the engagement groove 702 is formed on the master cylinder housing 7, and therefore the second embodiment can reduce the number of components compared to additionally providing a member fitted with the protruding portion 974.

(12) The magnet 96 is provided at the position opposite from the protruding portion 974 in the circumferential direction.

Therefore, the second embodiment allows the magnet holder 97 and the large-dimeter portion 70a to be two-fold symmetric with respect to the axial line O due to the identical shapes of the protruding portion 974 and the magnet holding portion 971, and the identical shapes of the engagement groove 702 and the groove portion 703. As a result, the second embodiment can improve assemblability when the magnet holder 97 is attached to the primary piston 51P.

### Third Embodiment

Next, a third embodiment will be described. The third embodiment has a basic configuration similar to the second embodiment, and therefore will be described focusing on only differences therefrom.

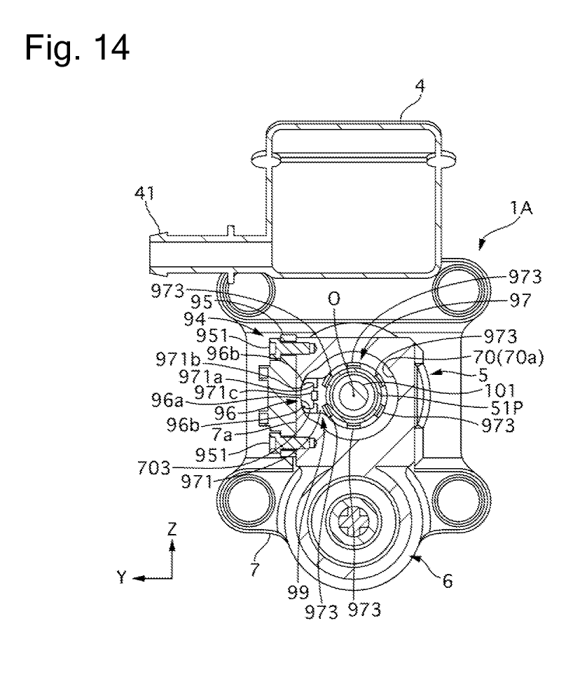

FIG. 14 is a cross-sectional view of the third embodiment taken along the line S8-S8 illustrated in FIG. 4.

The third embodiment is different from the second embodiment in terms of omission of the protruding portion 974 and the engagement groove 702, of abutment between the magnet holding portion 971 and the groove portion 703, and of circumferential fitted engagement between the magnet holding portion 971 and the groove portion 703. In other words, in the third embodiment, the magnet holding portion 971 and the groove portion 703 are used to function as the rotation restriction mechanism 99.

The third embodiment brings about the following advantageous effects.

(13) The magnet 96 is provided on the magnet holding portion 971 of the magnet holder 97. The magnet holding portion 971 is fitted with the groove portion 703 provided on the master cylinder housing 7 in the circumferential direction.

Therefore, the third embodiment causes the magnet holding portion 971 holding the magnet 96 to also serve as the rotation prohibition structure, thereby allowing the brake apparatus to acquire a simplest rotation prohibition structure.

### Fourth Embodiment

Next, a fourth embodiment will be described. The fourth embodiment has a basic configuration similar to the first embodiment, and therefore will be described focusing on only differences therefrom.

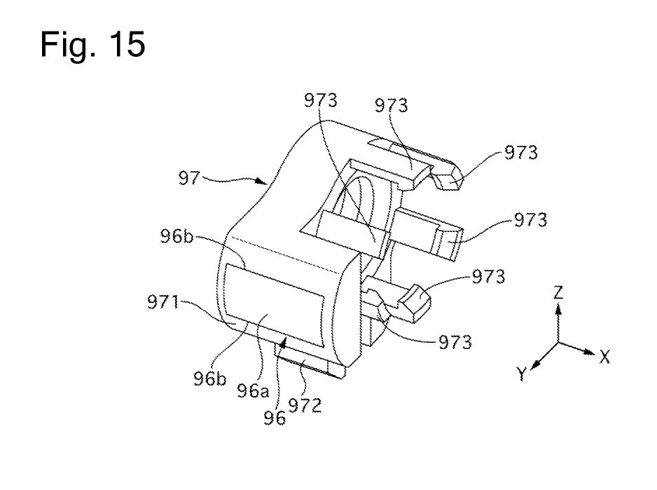

FIG. 15 is a perspective view of the magnet holder 97 according to the fourth embodiment.

The magnet 96 according to the fourth embodiment is joined to the magnet 97 by insert molding. In the insert molding, first, the magnet 96 is set in a mold for molding the magnet holder. After that, resin is introduced therein, and is cured with the magnet 96 wrapped by melted resin. By this method, a magnet holder sub-assembly, in which the magnet 96 and the magnet holder 97 are integrated, can be acquired.

The fourth embodiment brings about the following advantageous effect.

(14) The magnet 96 is integrated with the magnet holder 97 by the inert-molding.

Therefore, the fourth embodiment allows the magnet 96 and the magnet holder 97 to be integrated when the resin is molded, thereby preventing or reducing rattling of the magnet 96. As a result, the fourth embodiment can improve the accuracy of the detection of the stroke of the primary piston 51P. Further, the fourth embodiment allows the magnet 96 and the magnet holder 97 to be assembled at a molding stage, thereby achieving efficiency of the process.

### Other Embodiments

Having described embodiments for implementing the present invention based on the exemplary embodiments thereof, the specific configuration of the present invention is not limited to the configurations indicated in the exemplary embodiments, and the present invention also includes even a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

For example, in the above-described embodiments, the first unit 1A includes the master cylinder 5 and the stroke simulator 6, but the master cylinder 5 and the stroke simulator 6 may be individually provided as different units from each other. Further, the stroke simulator 6 may be integrally provided in the second unit 1B instead of the first unit 1A. Further, in the above-described embodiments, the detection portion 95 of the stroke sensor 94 is provided outside the master cylinder housing 7, but may be provided in a different manner as long as the detection portion 95 and the magnet 96 are disposed close to each other. For example, the detection portion 95 may be integrally provided inside the master cylinder housing 7.

Further, for example, a PWM duty signal according to the value of the voltage generated by the Hall element may be used as the sensor signal of the detection portion. Further, a coil may be used in place of the Hall element.

In the following description, technical ideas recognizable from the above-described embodiments will be described.

A brake apparatus, according to one configuration thereof, includes a master cylinder housing including a cylinder therein, a piston provided inside the cylinder and movable in an axial direction, when the axial direction is a direction of an axial line of the cylinder, a magnet provided, inside the cylinder, partially in a circumferential direction of the piston, when the circumferential direction is a direction around the axial line, and configured to be displaced according to a movement of the piston, a detection portion provided outside the master cylinder housing and configured to detect a movement amount of the piston, and a rotation restriction mechanism provided inside the cylinder and configured to restrict a movement of the magnet in the circumferential direction.

According to more preferable configuration, in the above-described configuration, the rotation restriction mechanism includes an engaged member attached so as to be restricted regarding a movement in the axial direction and permitted to move in the circumferential direction, relative to the piston. The engaged member includes an engaged portion configured in such a manner that a movement thereof relative to the master cylinder housing in the circumferential direction is restricted.

According to another preferable configuration, in any of the above-described configurations, the rotation restriction mechanism includes a guide pin. One end side of the guide pin in the axial direction is fixed to the master cylinder housing, and the other end side of the guide pin in the axial direction is fitted with the engaged portion in the circumferential direction.

According to further another preferable configuration, in any of the above-described configurations, the magnet is provided on the engaged member. An outer peripheral portion of the magnet on an outer side in a radial direction is shaped so as to conform with an inner peripheral portion of the master cylinder housing, when the radial direction is a direction radially extending from the axial line.

According to further another preferable configuration, in any of the above-described configurations, the engaged member includes a first engagement claw configured to hold the magnet.

According to further another preferable configuration, in any of the above-described configurations, the piston includes an engaged recess portion. The engaged member includes a plurality of second engagement claws configured to be engaged with the engaged recess portion in the axial direction.

According to further another preferable configuration, in any of the above-described configurations, the master cylinder housing includes a female screw portion. The guide pin includes a male screw portion on the one end side. The male screw portion is configured to be threadably engaged with the female screw portion.

According to further another preferable configuration, in any of the above-described configurations, the magnet is integrated with the engaged member by insert-molding.

According to further another preferable configuration, in any of the above-described configurations, the guide pin is provided on a lower side in a direction of gravitational force with respect to the piston with the brake apparatus mounted on a vehicle. The detection portion is provided at a side of the master cylinder housing with the brake apparatus mounted on the vehicle.

According to further another preferable configuration, in any of the above-described configurations, the rotation restriction mechanism includes an engagement groove provided on an inner peripheral surface of the cylinder and configured to be fitted with the engaged portion in the circumferential direction.

According to further another preferable configuration, in any of the above-described configurations, the magnet is provided on the engaged member. The outer peripheral portion of the magnet on the outer side in the radial direction is shaped so as to conform with the inner peripheral portion of the master cylinder housing, when the radial direction is the direction radially extending from the axial line.

According to further another preferable configuration, in any of the above-described configurations, the magnet is provided at a position opposite from the engaged portion in the circumferential direction.

According to further another preferable configuration, in any of the above-described configurations, the magnet is provided on the engaged portion.

Further, from another aspect, a brake system, according to one configuration thereof, includes a master cylinder, a first unit, and a second unit. The master cylinder includes a master cylinder housing including a cylinder therein, a piston provided inside the cylinder and movable in an axil direction, when the axial direction is a direction of an axial line of the cylinder, a magnet provided, inside the cylinder, partially in a circumferential direction of the piston, when the circumferential direction is a direction around the axial line, and configured to be displaced according to a movement of the piston, and a rotation restriction mechanism provided inside the cylinder and configured to restrict a movement of the magnet in the circumferential direction. The first unit includes a detection portion provided outside the master cylinder and configured to detect a movement amount of the piston, and a stroke simulator configured in such a manner that brake fluid flowing out from the master cylinder is introduced therein. The stroke simulator is configured to generate a simulated operation reaction force of a brake operation member. The second unit includes a second unit housing connected to the first unit and including an oil passage therein, and a hydraulic pressure source provided inside the second unit housing and configured to generate a hydraulic pressure in a wheel cylinder mounted at a wheel via the oil passage.

Preferably, in the above-described configuration, the rotation restriction mechanism includes an engaged member attached so as to be restricted regarding a movement in the axial direction and permitted to move in the circumferential direction, relative to the piston. The engaged member includes an engaged portion configured in such a manner that a movement thereof relative to the master cylinder housing in the circumferential direction is restricted.

According to another preferable configuration, in any of the above-described configurations, the rotation restriction mechanism includes a guide pin. One end side of the guide pin in the axial direction is fixed to the master cylinder housing, and the other end side of the guide pin in the axial direction is fitted with the engaged portion in the circumferential direction.

According to further another preferable configuration, in any of the above-described configurations, the rotation restriction mechanism includes an engagement groove provided on an inner peripheral surface of the cylinder and configured to be fitted with the engaged portion in the circumferential direction.

Further, from another aspect, a master cylinder, according to one configuration thereof, forms a brake apparatus and is configured to generate a brake hydraulic pressure by a brake operation. The master cylinder includes a master cylinder housing including a cylinder therein, a piston provided inside the cylinder and movable in an axial direction, when the axial direction is a direction of an axial line of the cylinder, a magnet provided, inside the cylinder, partially in a circumferential direction of the piston, when the circumferential direction is a direction around the axial line, and configured to be displaced according to a movement of the piston, and a rotation restriction mechanism provided inside the cylinder and configured to restrict a movement of the magnet in the circumferential direction.

Preferably, in the above-described configuration, the rotation restriction mechanism includes an engaged member attached so as to be restricted regarding a movement in the axial direction and permitted to move in the circumferential direction, relative to the piston. The engaged member includes an engaged portion configured in such a manner that a movement thereof relative to the master cylinder housing in the circumferential direction is restricted.

According to another preferable configuration, in any of the above-described configurations, the rotation restriction mechanism includes a guide pin. One end side of the guide pin in the axial direction is fixed to the master cylinder housing, and the other end side of the guide pin in the axial direction is fitted with the engaged portion in the circumferential direction.

According to further another preferable configuration, in any of the above-described configurations, the rotation restriction mechanism includes an engagement groove provided on an inner peripheral surface of the cylinder and configured to be fitted with the engaged portion in the circumferential direction.

The present application claims priority to Japanese Patent Application No. 2016-026640 filed on Feb. 16, 2016. The entire disclosure of Japanese Patent Application No. 2016-026640 filed on Feb. 16, 2016 including the specification, the claims, the drawings, and the abstract is incorporated herein by reference in its entirety.

### REFERENCE SIGN LIST

W/C wheel cylinder
1A first unit
1B second unit
3 pump (hydraulic pressure source)
5 master cylinder
6 stroke simulator
7 master cylinder housing
51P primary piston
51S secondary piston
70 cylinder
94 stroke sensor
95 detection portion
96 magnet
96a outer peripheral portion
97 magnet holder (engaged member)
98 guide pin
99 rotation restriction mechanism
702 engagement groove
972 two-surface width portion (engaged portion)

1. A brake apparatus comprising:
a master cylinder housing including a cylinder therein;
a piston provided inside the cylinder and movable in a direction of an axial line of the cylinder;
a magnet provided, inside the cylinder, partially in a circumferential direction of the piston, which is a direction around the axial line, and configured to be displaced according to a movement of the piston;
a detection portion provided on the master cylinder housing and configured to detect a movement amount of the piston; and
a rotation restriction mechanism provided inside the cylinder and configured to restrict a movement of the magnet in the circumferential direction.

2. The brake apparatus according to claim 1, wherein the rotation restriction mechanism includes an engaged member attached so as to be permitted to move in the circumferential direction while being restricted regarding a movement in the direction of the axial line relative to the piston, and
wherein the engaged member includes an engaged portion configured in such a manner that a movement thereof relative to the master cylinder housing in the circumferential direction is restricted.

3. The brake apparatus according to claim 2, wherein the rotation restriction mechanism includes a guide pin, and
wherein one end side of the guide pin in the direction of the axial line is fixed to the master cylinder housing, and an opposite end side of the guide pin in the direction of the axial line is fitted with the engaged portion in the circumferential direction.

4. The brake apparatus according to claim 3, wherein the magnet is provided on the engaged member, and
wherein an outer peripheral portion of the magnet on an outer side in a radial direction extending from the axial line is shaped so as to conform with an outer peripheral portion of the piston on the outer side in the radial direction.

5. The brake apparatus according to claim 4, wherein the engaged member includes a first engagement claw configured to hold the magnet.

6. The brake apparatus according to claim 5, wherein the piston includes an engaged recess portion, and
wherein the engaged member includes a plurality of second engagement claws configured to be engaged with the engaged recess portion in the direction of the axial line.

7. The brake apparatus according to claim 6, wherein the master cylinder housing includes a female screw portion, and
wherein the guide pin includes a male screw portion on the one end side, the male screw portion being configured to be threadably engaged with the female screw portion.

8. The brake apparatus according to claim 4, wherein the magnet is integrated with the engaged member by insert-molding.

9. The brake apparatus according to claim 3, wherein the guide pin is provided on a lower side in a direction of gravitational force with respect to the piston with the brake apparatus mounted on a vehicle, and
wherein the detection portion is provided at a side of the master cylinder housing with the brake apparatus mounted on the vehicle.

10. The brake apparatus according to claim 2, wherein the rotation restriction mechanism includes an engagement groove provided on an inner peripheral surface of the cylinder and configured to be fitted with the engaged portion in the circumferential direction.

11. The brake apparatus according to claim 10, wherein the magnet is provided on the engaged member, and
wherein an outer peripheral portion of the magnet on an outer side in a radial direction extending from the axial line is shaped so as to conform with an outer peripheral portion of the piston on the outer side in the radial direction.

12. The brake apparatus according to claim 11, wherein the magnet is provided at a position opposite from the engaged portion in the circumferential direction.

13. The brake apparatus according to claim 11, wherein the magnet is provided on the engaged portion.

14. A brake system comprising:
a master cylinder;
a first unit; and
a second unit,
wherein the master cylinder includes
a master cylinder housing including a cylinder therein,
a piston provided inside the cylinder and movable in a direction of an axial line of the cylinder,
a magnet provided, inside the cylinder, partially in a circumferential direction of the piston, which is a direction around the axial line, and configured to be displaced according to a movement of the piston, and
a rotation restriction mechanism provided inside the cylinder and configured to restrict a movement of the magnet in the circumferential direction,
wherein the first unit includes
a detection portion provided on the master cylinder and configured to detect a movement amount of the piston, and
a stroke simulator configured in such a manner that brake fluid flowing out from the master cylinder is introduced therein, the stroke simulator being configured to generate a simulated operation reaction force of a brake operation member, and
wherein the second unit includes
a second unit housing connected to the first unit and including an oil passage therein, and
a hydraulic pressure source provided inside the second unit housing and configured to generate a hydraulic pressure in a wheel cylinder mounted at a wheel via the oil passage.

15. The brake system according to claim 14, wherein the rotation restriction mechanism includes an engaged member attached so as to be permitted to move in the circumferential direction while being restricted regarding a movement in the direction of the axial line relative to the piston, and
wherein the engaged member includes an engaged portion configured in such a manner that a movement thereof relative to the master cylinder housing in the circumferential direction is restricted.

16. The brake system according to claim 15, wherein the rotation restriction mechanism includes a guide pin, and
wherein one end side of the guide pin in the direction of the axial line is fixed to the master cylinder housing, and an opposite end side of the guide pin in the direction of the axial line is fitted with the engaged portion in the circumferential direction.

17. The brake system according to claim 15, wherein the rotation restriction mechanism includes an engagement groove provided on an inner peripheral surface of the cylinder and configured to be fitted with the engaged portion in the circumferential direction.

18. A master cylinder forming a brake apparatus and configured to generate a brake hydraulic pressure by a brake operation, the master cylinder comprising:
a master cylinder housing including a cylinder therein;
a piston provided inside the cylinder and movable in a direction of an axial line of the cylinder;
a magnet provided, inside the cylinder, partially in a circumferential direction of the piston, which is a direction around the axial line, and configured to be displaced according to a movement of the piston; and
a rotation restriction mechanism provided inside the cylinder and configured to restrict a movement of the magnet in the circumferential direction.

19. The master cylinder according to claim 18, wherein the rotation restriction mechanism includes an engaged member attached so as to be permitted to move in the circumferential direction while being restricted regarding a movement in the direction of the axial line relative to the piston, and
wherein the engaged member includes an engaged portion configured in such a manner that a movement thereof relative to the master cylinder housing in the circumferential direction is restricted.

20. The master cylinder according to claim 19, wherein the rotation restriction mechanism includes a guide pin, and
wherein one end side of the guide pin in the direction of the axial line is fixed to the master cylinder housing, and an opposite end side of the guide pin in the direction of the axial line is fitted with the engaged portion in the circumferential direction.

21. The master cylinder according to claim 19, wherein the rotation restriction mechanism includes an engagement groove provided on an inner peripheral surface of the cylinder and configured to be fitted with the engaged portion in the circumferential direction.
